(19) United States
(12) Patent Application Publication
(10) Pub. No.: US 2025/0093159 A1
(43) Pub. Date: Mar. 20, 2025

(54) Indoor Localization Based on Multiple Device Sensors

(71) Applicant: Google LLC

(72) Inventor: Dongeek Shin, San Jose, CA (US)

(21) Appl. No.: 18/013,327

(22) PCT Filed: Dec. 14, 2022
(86) PCT No.: PCT/US2022/052821

§ 371 Date: Dec. 28, 2022

(51) Int. Cl. G01C 21/16

(52) U.S. Cl. CPC G01C 21/16

(57) ABSTRACT

Example embodiments of the present disclosure provide for an example method including obtaining location data associated with a first and second computing device. Example method can include determining an on-user device status for the each of the first and second computing devices. Example method can include obtaining inertial measurement unit (IMU) sensor data from each of the first and second computing devices. Example method can include inputting the IMU sensor data from each of the first and second computing devices into a machine learned model. Example method can include obtaining, from the machine learned model, output data indicative of a predicted location. Example method can include comparing the output data indicative of the predicted location to data indicative of a location of a target subzone. Example method can include transmitting data which instructs a user interface of the first computing device to provide a content item for display.

### FIELD

The present disclosure relates generally to localization using data from multiple sensors. More particularly, the present disclosure relates to reconciling data from multiple sensors to determine indoor localization of computing devices located on a user.

### BACKGROUND

Computing devices can be associated with a plurality of sensors. Sensor data can be obtained and used to determine device localization.

### SUMMARY

Aspects and advantages of embodiments of the present disclosure will be set forth in part in the following description, or can be learned from the description, or can be learned through practice of the embodiments.

In one example aspect, the present disclosure provides for an example system for indoor localization based on multiple device sensors, including one or more processors and one or more memory device storing instructions that are executable to cause the one or more processors to perform operations. In some implementations, the one or more memory devices can include one or more transitory or non-transitory computer-readable media storing instructions that are executable to cause the one or more processors to perform operations. In the example system, the operations can include obtaining location data associated with a first computing device and a second computing device, the location data indicative of the first computing device and the second computing device each being at a target location. In the example system, the operations can include in response to obtaining the location data, determining an on-user device status for the each of the first and second computing devices. In the example system, the operations can include in response to determining an on-user device status for each of the first and second computing devices, obtaining inertial measurement unit (IMU) sensor data from each of the first and second computing devices. In the example system, the operations can include inputting the IMU sensor data from each of the first and second computing devices into a machine learned model, wherein the machine learned model is configured to combine the IMU sensor data from each of the first and second computing devices. In the example system, the operations can include obtaining, from the machine learned model, output data indicative of a predicted location. In the example system, the operations can include comparing the output data indicative of the predicted location to data indicative of a location of a target subzone. In the example system, the operations can include in response to obtaining data indicative of colocation of each of the first and second computing devices within the target subzone of the target location, transmitting data which instructs a user interface of the first computing device to provide a content item for display.

In some embodiments of the example system, the on-user device status for each of the first and second computing devices are indicative of each of the first and second computing devices being located on a user moving inside the target location.

In some embodiments of the example system, the IMU sensor data comprises accelerometer data and gyroscope data.

In some embodiments of the example system, the machine learned model is configured to transform the accelerometer data and the gyroscope data to data cartesian coordinates indicative of an absolute location.

In some embodiments of the example system, the operations include obtaining IMU sensor data from a third computing device.

In some embodiments of the example system, the first computing device comprises a smartphone, the second computing device comprises a smartwatch, and the third computing device comprises earbuds.

In some embodiments of the example system, the computing is performed on the first computing device.

In some embodiments of the example system, the IMU sensor data from each of the first and second computing devices are combined using a fusion method.

In some embodiments of the example system, the machine learned model comprises a neural network.

In some embodiments of the example system, the machine learned model comprises a fully connected neural network.

In some embodiments of the example system, the first computing device is a primary computing device and the second computing device is a secondary computing device. In some embodiments of the example system, the first computing device functions as a modem to facilitate transmission of data between the second computing device and a server computing system.

In an example aspect, the present disclosure provides for an example computer-implemented method. The example method includes obtaining location data associated with a first computing device and a second computing device, the location data indicative of the first computing device and the second computing device each being at a target location. In the example method, the method includes in response to obtaining the location data, determining an on-user device status for the each of the first and second computing devices. In the example method, the method includes in response to determining an on-user device status for each of the first and second computing devices, obtaining inertial measurement unit (IMU) sensor data from each of the first and second computing devices. In the example method, the method includes inputting the IMU sensor data from each of the first and second computing devices into a machine learned model, wherein the machine learned model is configured to combine the IMU sensor data from each of the first and second computing devices. In the example method, the method includes obtaining, from the machine learned model, output data indicative of a predicted location. In the example method, the method includes comparing the output data indicative of the predicted location to data indicative of a location of a target subzone. In the example method, the method includes in response to obtaining data indicative of colocation of each of the first and second computing devices within the target subzone of the target location, transmitting data which instructs a user interface of the first computing device to provide a content item for display.

In some embodiments of the example method, the on-user device status for each of the first and second computing devices are indicative of each of the first and second computing devices being located on a user moving inside the target location.

In some embodiments of the example method, the IMU sensor data comprises accelerometer data and gyroscope data.

In some embodiments of the example method, the machine learned model is configured to transform the accelerometer data and the gyroscope data to data cartesian coordinates indicative of an absolute location.

In some embodiments of the example method, the method includes obtaining IMU sensor data from a third computing device.

In some embodiments of the example method, the first computing device comprises a smartphone, the second computing device comprises a smartwatch, and the third computing device comprises earbuds.

In some embodiments of the example method, the computing is performed on the first computing device.

In some embodiments of the example method, the IMU sensor data from each of the first and second computing devices are combined using a fusion method.

In some embodiments of the example method, the machine learned model comprises a neural network.

In some embodiments of the example method, the machine learned model comprises a fully connected neural network.

In some embodiments of the example method, the first computing device is a primary computing device and the second computing device is a secondary computing device. In some embodiments of the example method, the first computing device functions as a modem to facilitate transmission of data between the second computing device and a server computing system.

In an example aspect, the present disclosure provides for an example transitory or non-transitory computer readable medium embodied in a computer-readable storage device and storing instructions that, when executed by a processor, cause the processor to perform operations. In the example transitory or non-transitory computer readable medium, the operations include obtaining location data associated with a first computing device and a second computing device, the location data indicative of the first computing device and the second computing device each being at a target location. In the example transitory or non-transitory computer readable medium, the operations include in response to obtaining the location data, determining an on-user device status for the each of the first and second computing devices. In the example transitory or non-transitory computer readable medium, the operations include in response to determining an on-user device status for each of the first and second computing devices, obtaining inertial measurement unit (IMU) sensor data from each of the first and second computing devices. In the example transitory or non-transitory computer readable medium, the operations include inputting the IMU sensor data from each of the first and second computing devices into a machine learned model, wherein the machine learned model is configured to combine the IMU sensor data from each of the first and second computing devices. In the example transitory or non-transitory computer readable medium, the operations include obtaining, from the machine learned model, output data indicative of a predicted location. In the example transitory or non-transitory computer readable medium, the operations include comparing the output data indicative of the predicted location to data indicative of a location of a target subzone. In the example transitory or non-transitory computer readable medium, the operations include in response to obtaining data indicative of colocation of each of the first and second computing devices within the target subzone of the target location, transmitting data which instructs a user interface of the first computing device to provide a content item for display.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an example block diagram of data flow according to example embodiments of the present disclosure.

FIGS. 2A-2B depict example device environments according to example embodiments of the present disclosure.

FIG. 3A depicts an example device environment and device location trajectories according to example embodiments of the present disclosure.

FIG. 3B depicts an example graphical representation of device location trajectories according to example embodiments of the present disclosure.

FIG. 4A depicts an example device environment and device location trajectories according to example embodiments of the present disclosure.

FIG. 4B depicts an example graphical representation of device location trajectories according to example embodiments of the present disclosure.

FIGS. 5-7 depict example block diagrams of data flow according to example embodiments of the present disclosure.

FIG. 8 depicts a flowchart of an example method according to example embodiments of the present disclosure.

FIGS. 9-10 depicts example block diagrams of example systems for performing indoor localization of user devices based on sensor data according to example embodiments of the present disclosure.

### DETAILED DESCRIPTION

Generally, the present disclosure is directed to systems and methods for obtaining sensor data from multiple devices associated with a user to be processed by a location prediction pipeline to predict an indoor location of a user. For example, the systems and methods can provide for more accurately performing localization of a user within a store by combining sensor data from a plurality of pseudo-wearable computing devices associated with a user. The prediction pipeline can obtain sensor data obtained from inertial measurement unit (IMU) sensors. The prediction pipeline can include a body on/off logic component. The prediction pipeline can include an IMU streaming component or a fusion component. The prediction pipeline includes a machine learned model that produces an output comprising a predicted user location comprising three degrees of freedom (e.g., xyz coordinates). The predicted user location can be used to perform a content selection and transmission process that results in content being served to the user responsive to the user location being within a threshold of a target location (e.g., within a meter of a particular section of store).

Indoor localization is difficult due to trade-offs between sensor specifications (e.g., broadcasting outer module (BOM), power, product form factor) and accuracy. While methods exist which employ the use of ultra-wideband (UWB) anchors, Wi-Fi sensors, quick response (QR) codes, near field communications (NFC), geofencing, radio frequency identification (RFID), Bluetooth low energy (BLE) beacons, etc. these methods can be expensive and require use of bulky form factor units. This implementation can be associated with an installation-user friction component. Alternatively, sole use of a high-cost sensorless smartphone can result in deterioration of accuracy. For example, indoor GPS or conventional three degrees of freedom (3DoF) solutions (e.g., measuring xyz device displacement) from the smartphone inertial measurement unit (IMU) can be inherently noisy.

The present disclosure provides for a solution that utilizes sensor data obtained from a multi-device first-party ecosystem that accompanies a user that has entered an indoor location (e.g., retail store). This solution is low friction and has increased accuracy. The devices in the first-party ecosystem can include wearable (or pseudo-wearable) devices such as smartphones, earbuds, smartwatches, laptop computers, tablets, etc. Each of these devices can obtain data via an IMU-like motion sensor. In some implementations, the system can translate the IMU-like sensor data into three degrees of freedom data for each device simultaneously. The system can perform a fusion step that combines the individual sensor datasets and performs a noise reduction process to estimate a noise-reduced three degrees of freedom result.

By way of example, a user can move within a physical location (e.g., store) with a smartphone and a smartwatch (or more devices). The walk movement signals can be synchronized between the two (or more) devices. By combining the sensor data obtained from the two devices, a common average can be determined to generate a more accurate localization result. The accuracy of the improvement can be correlated with the number of devices utilized in the process.

The localization of a user based on the user device sensor data can be used to predict or estimate a location of the user. The computing system can compare the predicted (or estimated) location with a target subzone. The computing system can determine that the user is located within the target subzone. In response to determining that the user is located within the target subzone, the computing system can perform a content selection process and provide one or more content items for display via an interface of a user device (e.g., graphical user interface of a phone, speaker of an earbud, graphical user interface of a smartwatch).

The present disclosure provides for many technical effects and benefits. For example, the system can more accurately determine a precise indoor user location (e.g., within a meter). The present disclosure provides for more robust data collection and process to accurately determine a precise location for a user to be used for various implementations. Indoor user localization is an important technology area with practical applications in a variety of technological fields. The technological fields can include more accurate localization for localizing individuals to implement safety measures (e.g., an individual that has fallen in a home, a user in an emergency), integration with internet of things (IoT) devices (e.g., within a home or office), or use of surfacing content to users in response to the user being located within a target subzone. Additionally, the system can perform many of these processes on a hub device (e.g., smartphone) thus, reducing bandwidth usage by lessening the amount of data that must be communicated off-device (e.g., via a network). Additionally, processing IMU sensor data can be more computationally efficient than processing GPS or other location data thus reducing the use of computational resources and bandwidth.

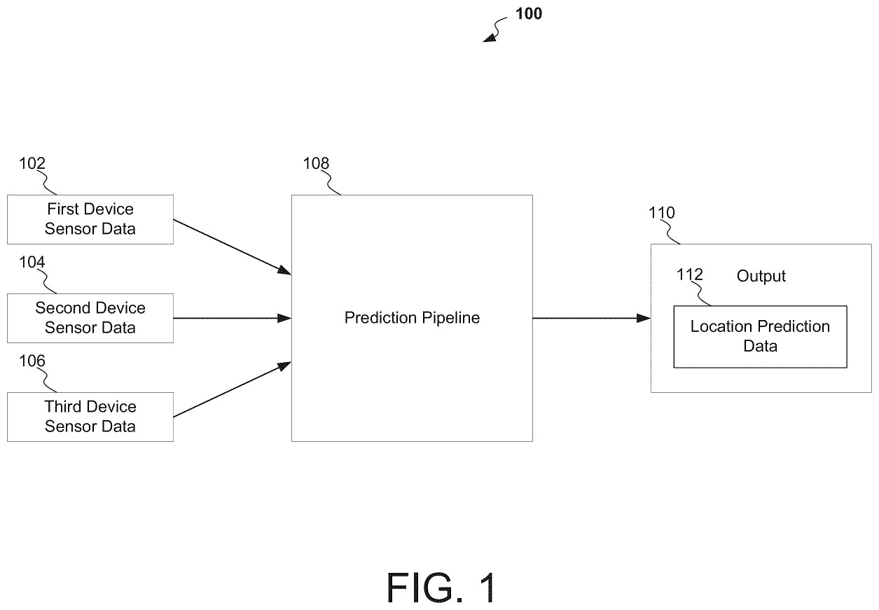

FIG. 1 Depicts an example data flow 100 according to embodiments of the present disclosure. Data flow 100 can include prediction pipeline 108 obtaining sensor data from devices. For example, prediction pipeline 108 can obtain first device sensor data 102, second device sensor data 104, and third device sensor data. First device, second device, and third device can be any kind of computing device. For example, the computing devices can be wearable computing devices or pseudo-wearable computing devices. By way of example the devices can include smartphones, smart watches, earbuds, fitness trackers, laptop computers, tablets, or any other computing device. The computing devices can include sensors. The sensors can include inertial measurement unit (IMU) sensors, ambient light sensors, accelerometer (e.g., 3-axis accelerometer), altimeter (detects change in height), optical hear rate sensor (detect heart beats per minute), SpO2 monitor (e.g., to measure blood oxygen levels), bioimpedance sensor(s), proximity sensor (e.g., to save battery and wake display when needed), compass, GPS, gyroscope, gesture sensors, ultraviolet (UV) sensor, magnetometer, electrodermal activity sensor, skin temperature sensor, accelerometer(s), gyroscope(s), magnetometer(s), global positioning system (GPS), heart rate sensor(s) (e.g., electrode sensor or photodiode), pedometer(s) (e.g., electrical, mechanical, or microelectromechanical), pressure sensor(s) (e.g., strain gauges), optical sensors, audio sensors, or other sensors.

Prediction pipeline 108 can obtain device sensor data including first device sensor data 102, second device sensor data, or third device sensor data 106. The prediction pipeline can process the device sensor data to determine output 110. Output 110 can include location prediction data 112. Location prediction data 112 can include a predicted location within an indoor environment (e.g., a target location). The computing system can process location prediction data 112 to perform actions. The actions can include serving content (e.g., to one of the user devices or a third-party device), facilitating provision of emergency services, or controlling devices (e.g., turning on lights, speakers, TV, or other IoT devices).

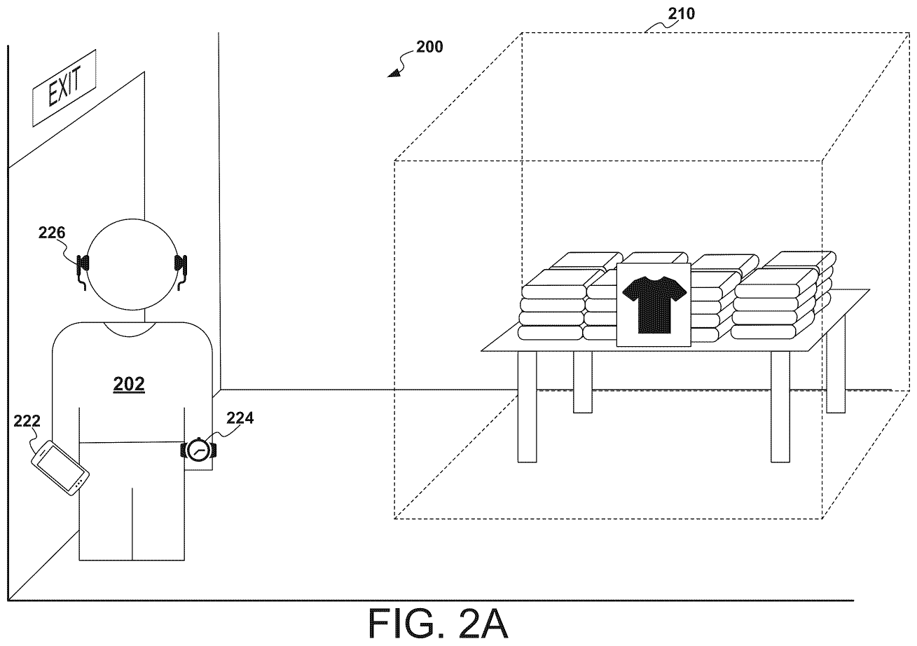

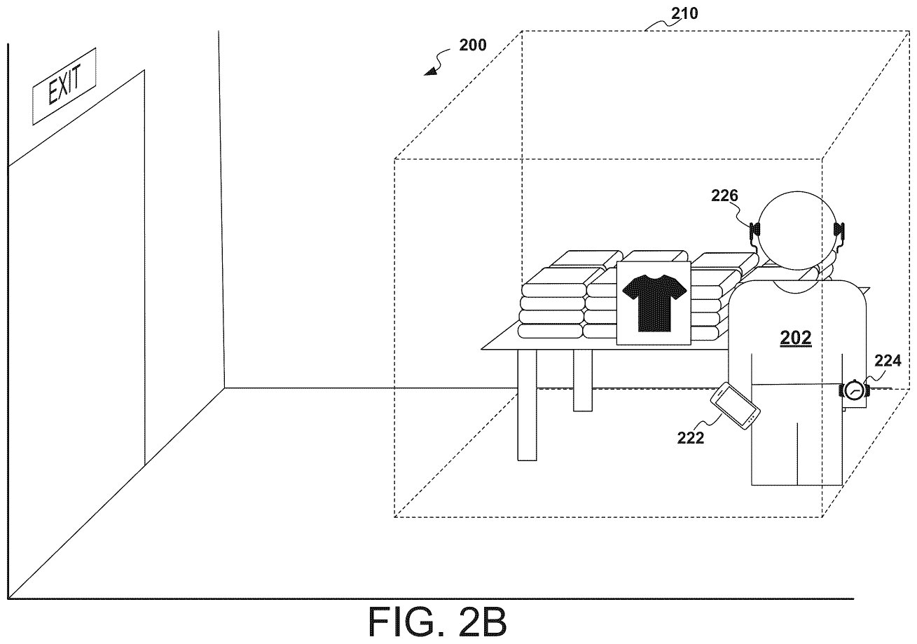

An example implementation of the present disclosure is determining an indoor location of a user in a target location (e.g., physical store location, relevant location, home location, work location). As depicted in FIG. 2A, user 202 can be located inside target location 200. User 202 can carry one or more devices. For example, devices can include first device 222 (e.g., a smartphone), second device 224 (e.g., a smartwatch), and third device 226 (e.g., earbuds). As described herein, devices can include any computing devices (e.g., smartphones, smart watches, earbuds, fitness trackers, laptop computers, or tablets). Target location 200 can include target subzone 210. A target subzone 210 can be associated with a particular portion of a target location (e.g., section, sign, display, or target subzone). When a user enters target location 200, the computing system can obtain sensor data from the user devices (e.g., first device 222, second device 224, third device 226). In some implementations, the computing system can determine the user has entered the target location. This determination can trigger further operations, including, for example, obtaining sensor data from the user devices associated with user 202. User devices can be part of a first-party ecosystem of devices that user 202 brings into the target location 200.

User 202 can walk around target location 200 to look at various items or visit different departments. As depicted in FIG. 2B, user 202 can walk into target subzone 210. The computing system can obtain sensor data from the computing devices (e.g., first device 222, second device 224, third device 226) associated with user 202. The computing system can determine a predicted location (e.g., estimated location) of user 202 (e.g., via prediction pipeline 108). The computing system can compare the predicted location with target subzone 210. Based on the comparison, the computing system can determine that user 202 is located within target subzone 210.

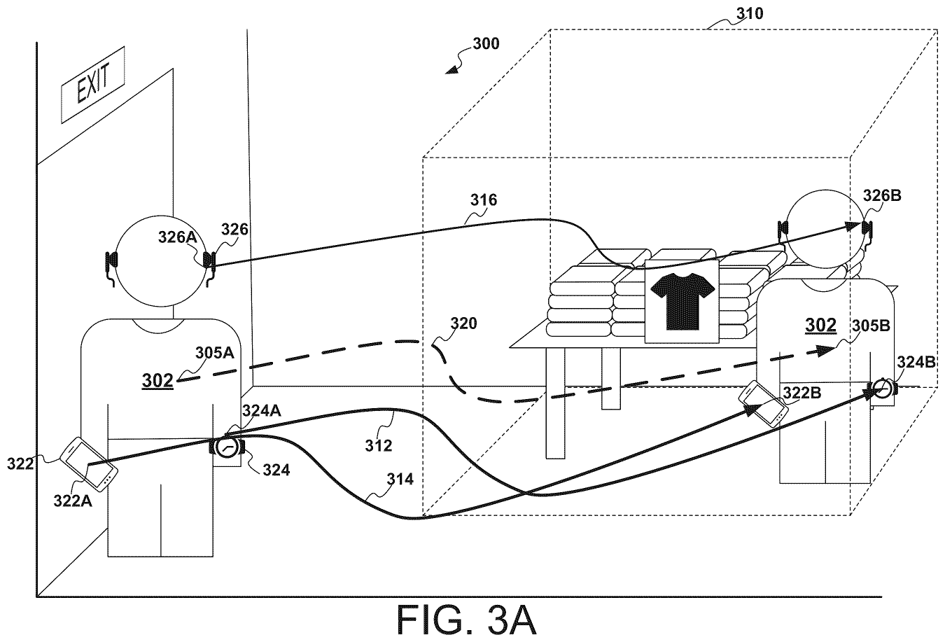

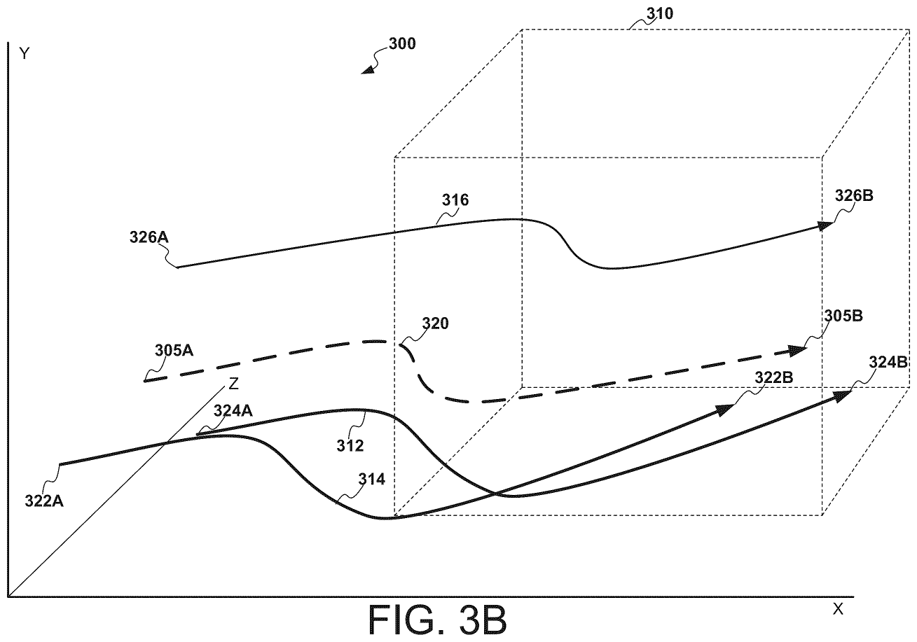

FIG. 3A depicts example trajectories of user 302 from first location 305A to second location 305B. User 302 can move in target location 300. For example, user 302 can move from a first location 305A (e.g., the entrance of target location 300) to a second location 305B (e.g., within target subzone 310). The depicted trajectories can include trajectory 312, trajectory 314, trajectory 316, and trajectory 320. Trajectory 312 can include data indicative of a plurality of locations between start location 322A and end location 322B of a sensor associated with user device 322 (e.g., first device 222). Trajectory 314 can include data indicative of a plurality of locations between start location 324A and end location 324B of a sensor associated with user device 324 (e.g., second device 224). Trajectory 316 can include data indicative of a plurality of locations between start location 326A and end location 326B of a sensor associated with user device 326 (e.g., third device 226). Trajectory 320 can be associated with a ground truth trajectory of user 302. Trajectory 320 can include data indicative of a plurality of locations between first location 305A and second location 305B.

In some implementations, the computing system can translate IMU sensor data to location data indicative of a location with three degrees of freedom (e.g., xyz coordinates (cartesian coordinates)). FIG. 3B depicts an example graphical representation of trajectories 312, 314, 316, and 320 in cartesian coordinates. The computing system can combine IMU sensor data directly or can transform the sensor data from IMU sensor data to data with three degrees of freedom (e.g., xyz coordinates). The computing system (e.g., via the prediction pipeline) can perform a fusion of the sensor data to generate an output (e.g., output 110). Output can include location prediction data (e.g., location prediction data 112) or predicted trajectory (e.g., predicted trajectory 425).

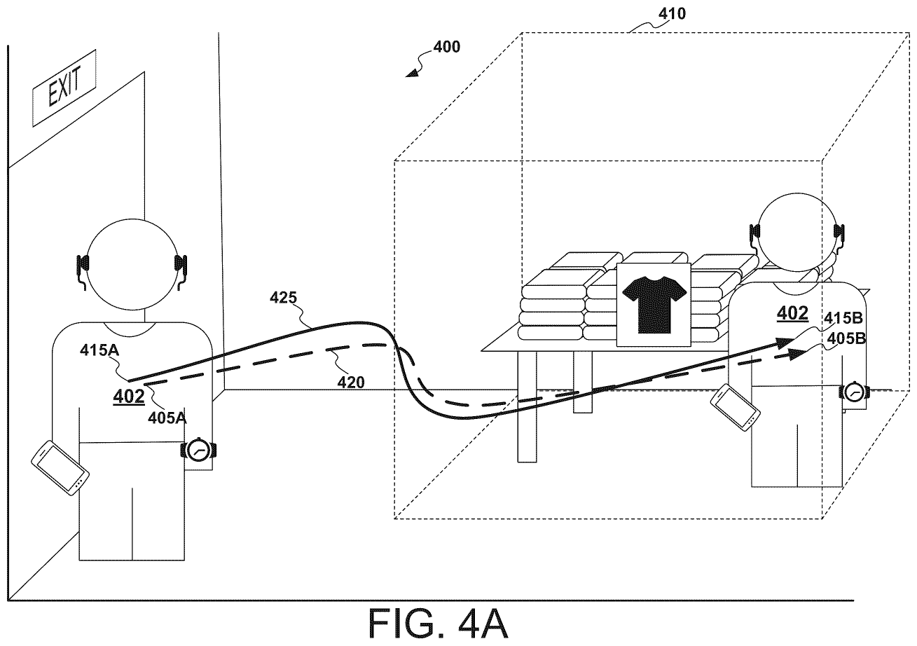

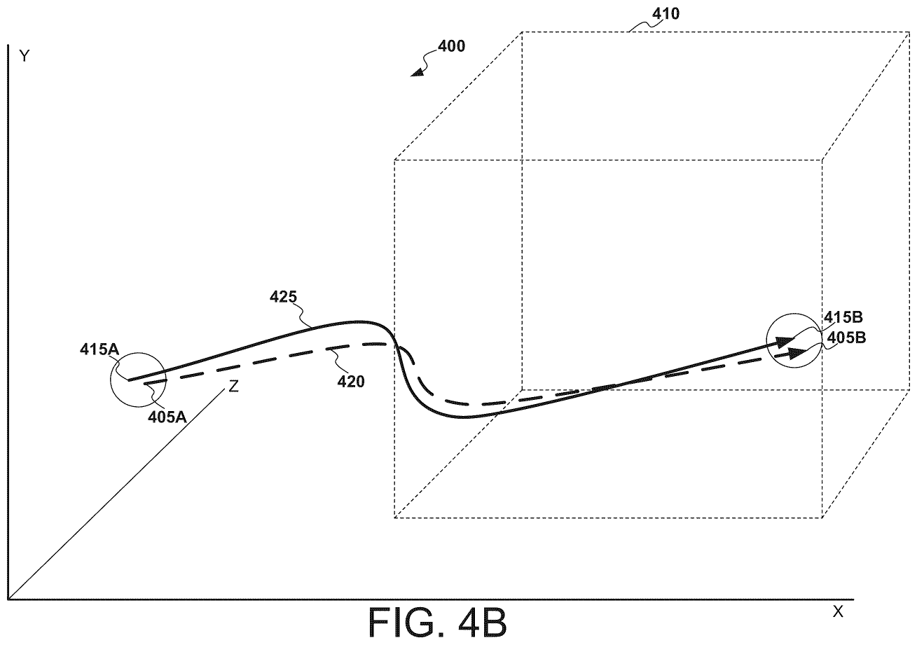

FIG. 4A depicts an example of predicted trajectory 425 and ground truth trajectory 420 of user 402 from first location 405A to second location 405B. User 402 can move inside target location 400. For example, user 402 can move from a first location 405A (e.g., the entrance of target location 400) to a second location 405B (e.g., within target subzone 410). The depicted trajectories can include ground truth trajectory 420 and predicted trajectory 425. Ground truth trajectory 420 can represent a known trajectory of user 402 from first location 405A to second location 405B. Predicted trajectory 425 can represent a predicted (e.g., combined) trajectory of a user (and associated devices) from first predicted location 415A to second predicted location 415B. Predicted trajectory 425 can be generated by performing a fusion of trajectories associated with a plurality of user devices (e.g., trajectories 312, 314, and 316). Predicted trajectory 425 can be determined to be within a threshold difference (e.g., margin of error of 5%, 1%, 0.5%, 0.05% or any other margin of error) from ground truth trajectory 420.

In some implementations, the computing system can translate IMU sensor data to location data indicative of a location with three degrees of freedom (e.g., xyz coordinates). FIG. 4B depicts an example graphical representation of trajectories 420 and 425. The computing system can combine IMU sensor data directly or can transform the sensor data from IMU sensor data to data with three degrees of freedom (e.g., xyz coordinates). The computing system (e.g., via the prediction pipeline) can perform a fusion of the sensor data to generate an output (e.g., output 110). Output can include location prediction data (e.g., location prediction data 112) or predicted trajectory (e.g., predicted trajectory 425).

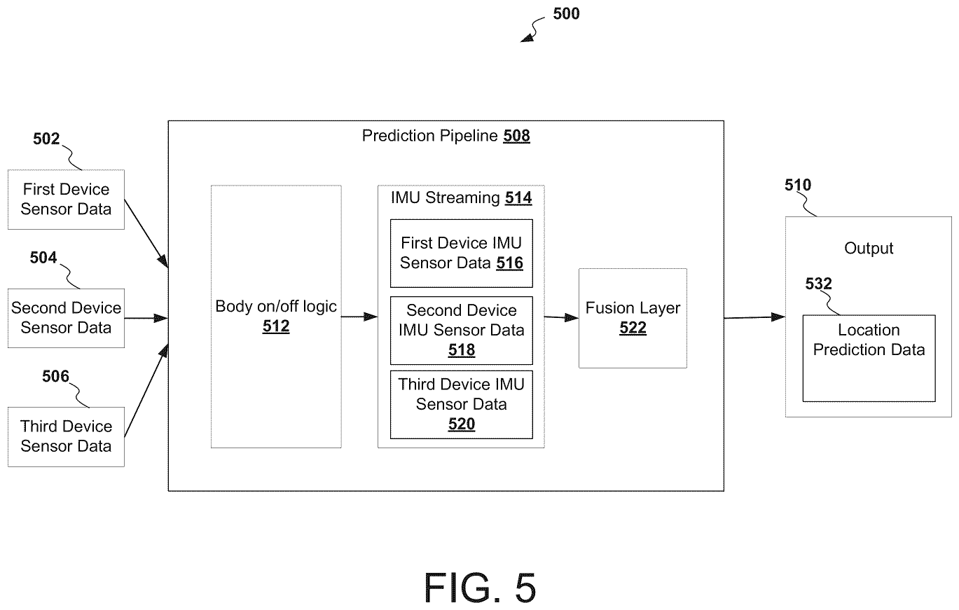

FIG. 5 depicts example data flow 500 according to implementations of the present disclosure. Data flow 500 can include obtaining first device sensor data 502, second device sensor data 504, or third device sensor data 506. The data flow can include inputting first device sensor data 502, second device sensor data 504, or third device sensor data 506 into prediction pipeline 508 and obtaining output 510. Output can include location prediction data 532.

Prediction pipeline 508 can include a body on/off logic 512, IMU Streaming 514, and fusion layer 522. Body on/off logic 512 can include determining whether a device is located on a user. Body on/off logic 512 can include the computing system determining if the respective devices are located on the user. For example, a user can have a plurality of associated devices. However, in some instances, a user may not have all devices “on body”. For example, a user may leave a smartphone, earbuds, or a smartwatch at home or on a table (or other surface) within a location. The computing system can perform operations to determine whether the device is located on a user (and collocated with other associated user devices).

In some implementations, body on/off logic can vary depending on the type of computing device. By way of example, a computing system can obtain sensor data associated with one or more computing devices. Sensors can include ambient light sensors, motion sensors, heart rate sensors, proximity sensors, optical sensors, or any other sensors.

A device can be a smartphone. Body on/off can be confirmed by determining if the smartphone is in a user's hand, in a user's pocket, in a user's bag, or otherwise located on the user. A smartphone can be determined as located in a user hand by analyzing low-frequency spectral energy from an IMU feature. If a device is located within a pocket or bag of a user, ambient light sensor (ALS) data can be analyzed to determine if an item is located in a dark location (e.g., similar to checking head-near-phone for phone calls).

A device can be a smartwatch. Body on/off can be confirmed by processing photoplethysmography (PPG) sensor data used for a heart rate measurement. If the direct current (DC) value of the reflective PPG is high, that measurement can indicate the reflected signal coming from an immediate occlusion such as skin or sub-dermal components of a human wrist which can indicate that the device is located “on body”.

A device can be a smart earbud (or a pair of smart earbuds). Body on/off can be confirmed by using proximity sensors, optical sensors, or audio sensors to measure an on-ear contact signal.

The computing system can determine that an on-user device status is indicative of a device being located on a user within a target location. In response, the computing system can perform an IMU streaming process to obtain data of the one or more devices located on the user. In some implementations, the computing system can determine that an on-user device status is indicative of a device not being located on a user within a target location. In response, the computing system can exclude the device and associated sensor data from the IMU streaming process.

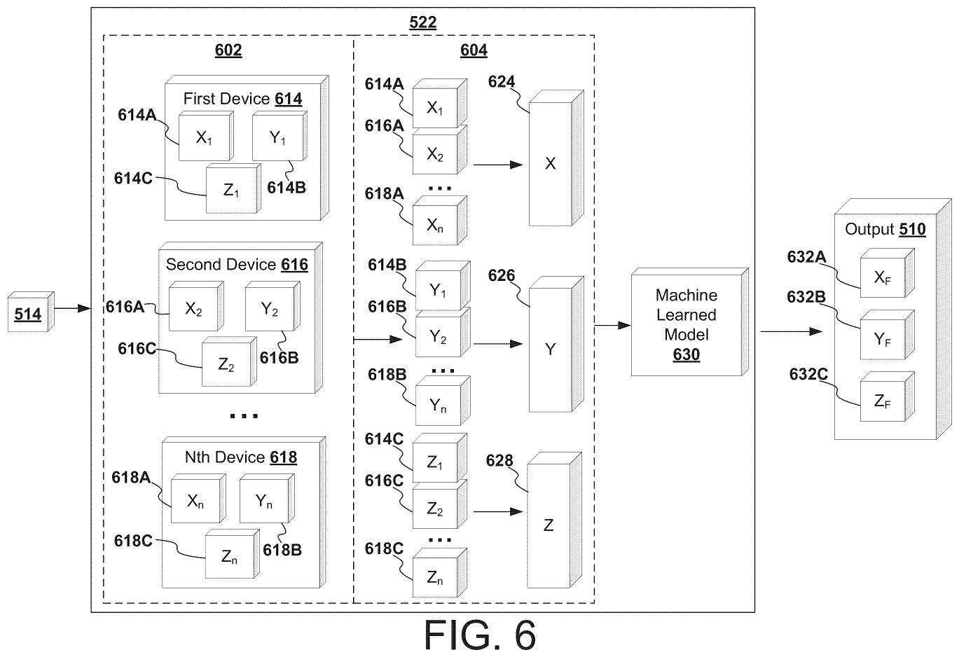

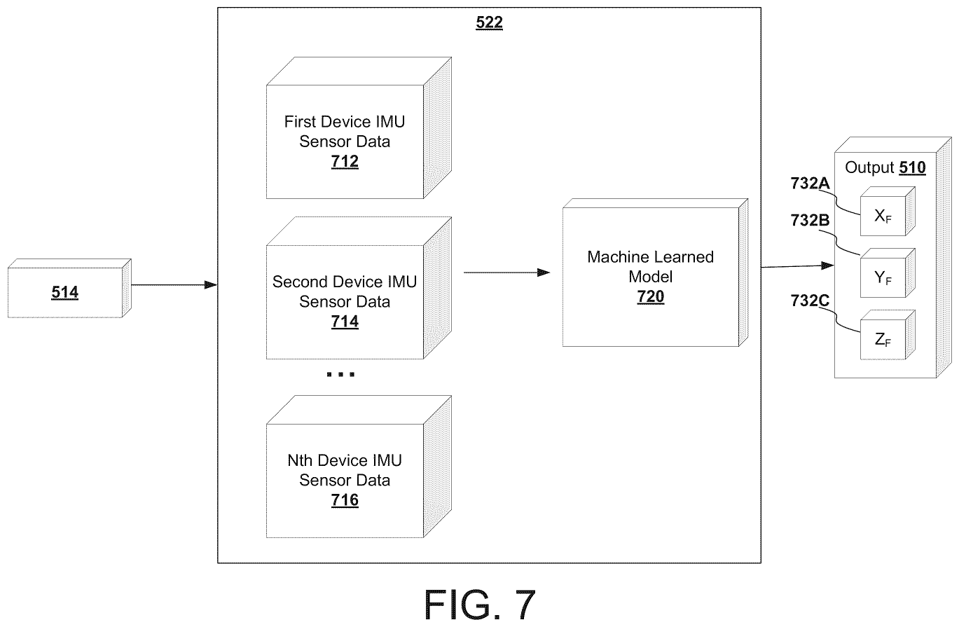

IMU streaming 514 can include, in response to determining a device is on the user (e.g., an on-user device status), obtaining IMU sensor data associated with the user. By way of example, by processing first device sensor data 502, second device sensor data 504, and third device sensor data 506 the computing system can determine that first device, second device, and third device are located on a user. In response, the computing system can obtain IMU sensor data associated with the devices (e.g., first device IMU sensor data 516, second device IMU sensor data 518, or third device IMU sensor data 520). The computing system can input the IMU sensor data into the fusion layer. The fusion layer 522 can include the system transforming the IMU sensor data to three degrees of freedom location data then performing fusion (e.g., as depicted in FIG. 7) or performing a fusion of the IMU sensor data directly (e.g., as depicted in FIG. 6).

In some implementations, fusion can occur on a computing device associated with the user (e.g., a first computing device). For instance, the computing device can stream data from the device origin to another device (e.g., from a second computing device to a first computing device, a user computing device to a server computing device). By way of example, the first computing device can serve as a hub for secondary computing devices (e.g., a phone with a smartwatch and earbuds communicatively connected). In some implementations the IMU sensor data can be transformed to three degrees of freedom which provides for more physically meaningful measurements (e.g., for humans to perform quality control checks). In some implementations the IMU sensor data can be fused without transformation to three degrees of freedom location data. Thus, in some implementations, machine learned models can be trained to learn subtitles of proper fusion to allow for merging the IMU data from multiple sensors/devices without transforming the sensor data to three degrees of freedom location data.

Turning to FIG. 6, fusion layer 522 can include obtaining data from IMU streaming 514 from the plurality of devices at data obtaining step 602. In fusion layer 522, the computing system can translate the data from IMU streaming 514 into location data represented in three degrees of freedom. This can include data associated with first device 614, second device 616, and Nth device 618. Location data of the first device 614 can include X₁ data 614A, Y₁ data 614B, and Z₁ data 614C. Location data of the second device 616 can include X₂ data 616A, Y₂ data 616B, and Z₂ data 616C. Location data of the Nth device 618 can include Xₙ data 618A, Yₙ data 618B, and Zₙ data 618C. There can be any number of devices associated with a user. For example, there can be two devices, three devices, four devices, up to N devices.

IMU sensor data can be translated into three degrees of freedom data using any means. For example, IMU sensor data can be translated into a three degrees of freedom trajectory. The system can perform a double integration to translate the acceleration or gyroscope measurements into three degrees of freedom (e.g., xyz coordinates) of location or translational representation of movement through the three-dimensional space (e.g., target location). Converting and combining the IMU sensor data from multiple devices can allow for more accurate indoor user localization by using the multi-device polling structure to make the use of IMU measurements more accurate.

The present system can obtain data from data obtaining step 602 and rearrange the data into respective degrees of freedom. For example, the computing system can group all X data together (X₁ data 614A, X₂ data 616A, Xₙ data 618A), all Y data together (Y₁ data 614B, Y₂ data 616B, Yₙ data 618B), all Z data (Z₁ data 614C, Z₂ data 616C, Zₙ data 618C) together in fusion step 604. At fusion step 604, the X data can be fused to form fused X data 624, the Y data can be fused to form fused Y data 626, and the Z data can be fused to form fused Z data 628. Machine learned model 630 can obtain the fused X data 624, fused Y data 626, and fused Z data 628. Machine learned model 630 can generate output 510. Output 510 can include location data including an X_{F} coordinate 632A, Y_{F} coordinate 632B, and Z_{F} coordinate 632C. The (X_{F}, Y_{F}, Z_{F},) can represent an absolute location of the devices associated with a user (e.g., the user) within the target location (e.g., target subzone 210, 310, 410).

Fusion can be performed in numerous ways. For example, fusion can be performed by a machine learned model. The machine learned model can be a neural network. In some implementations, the neural network can be a fully connected neural network. The machine learned model can be trained in an off-line process to perform the fusion process. The machine learned model can be trained in an online process. Machine learned model can be any machine learned model described here. Machine learned model can be trained using any machine learned model training process.

Turning to FIG. 7, fusion layer 522 can include a fusion of IMU sensor data. For example, the computing system can obtain first device IMU sensor data 712, second device IMU sensor data 714, and device n IMU sensor data 716 (or data from a plurality of devices). The computing system can input the device IMU sensor data (first device IMU sensor data 712, second device IMU sensor data 714, and device n IMU sensor data 716) into machine learned model 720. Fusion can be performed in numerous ways. For example, fusion can be performed by a machine learned model. The machine learned model can be a neural network. In some implementations, the neural network can be a fully connected neural network. The machine learned model can be trained in an off-line process to perform the fusion process. The machine learned model can be trained in an online process. Machine learned model can be any machine learned model described here. Machine learned model can be trained using any machine learned model training process.

Machine learned model 720 can process the IMU sensor data (e.g., first device IMU sensor data 712, second device IMU sensor data 714, and device n IMU sensor data 716). The computing system can obtain output 510. Output 510 can include location data including an X_{F} coordinate 732A, Y_{F} coordinate 732B, and Z_{F} coordinate 732C. The (X_{F}, Y_{F}, Z_{F},) can represent an absolute location of the devices associated with a user (e.g., the user) within the target location (e.g., target subzone 210, 310, 410).

Turning back to FIG. 5, the computing system can obtain output 510. Output 510 can include location prediction data 532. Location prediction data 532 can include, for example, a predicted absolute location of a user in an indoor location. For example, the absolute location can be predicted within a meter of accuracy.

The absolute location can be determined by combining an identified start location (e.g., an entrance of a target location) obtained via a sensor (e.g., GPS, using Wi-Fi connection strength). This can be used as a starting reference point to determine the absolute location. An example method for determining absolute location can include filtering the IMU sensor data. An example method for determining absolute location can include performing double integration on the IMU sensor data to translate the IMU sensor data (e.g., accelerometer data, gyroscope data) to a location in three degrees of freedom or trajectory in three degrees of freedom.

The computing system can use the output to perform various operations (or actions). For example, the computing system can compare the predicted location of the user (and associated devices) to a target subzone (e.g., target subzone 210, target subzone 310, target subzone 410) within a target location (e.g., target location 200, target location 300, target location 400).

By way of example, an action can include transmitting instructions to one or more of the user devices associated with a user that causes a content item to be displayed on at least one of the user devices associated with the user. For example, a content item could be informational, provide a selectable user interface element (e.g., hyperlink, button), content associated with a particular portion of a store, or other content relevant to the user's indoor location. In some implementations, a content item can include an advertisement. For example, a target subzone can be associated with a particular item (e.g., a shirt). The computing system can obtain output indicative of a predicted location of the user and compare the predicted location to a target subzone. If the user predicted location is within a threshold of the target subzone, the computing system can transmit data which causes a content item (e.g., a message indicating “buy one get one free”) relating to the target subzone.

In some implementations, a target location can be a location associated with a users' work or home environment. The users' work or home environment can include a plurality of IoT devices. The computing system can determine a user location within the environment and perform actions based on the determined location. By way of example, a user can walk within a target subzone associated with a particular smart device (e.g., light, tv, refrigerator, speaker, oven, etc.) and in response to the user's predicted location being within a threshold of the target subzone, the computing system can perform an action associated with the smart device (e.g., and IoT device). In some implementations, the predicted location can be used in safety related implementations. For example, the predicted location can be indicative of user falling (e.g., an initial three degrees of freedom location indicative of a higher z coordinate location and a final three degrees of freedom location indicative of a low z coordinate location). Additionally, or alternatively, the predicted location can be used by emergency services to determine if a user is within a target location or specifically where the user is located (e.g., in the event of a fire, evacuation, or other emergency).

Further to the descriptions above, a user may be provided with controls allowing the user to make an election as to both if and when systems, programs, or features described herein may enable collection of user information (e.g., information about a user's activity or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how the information is used, and what information is provided to the user.

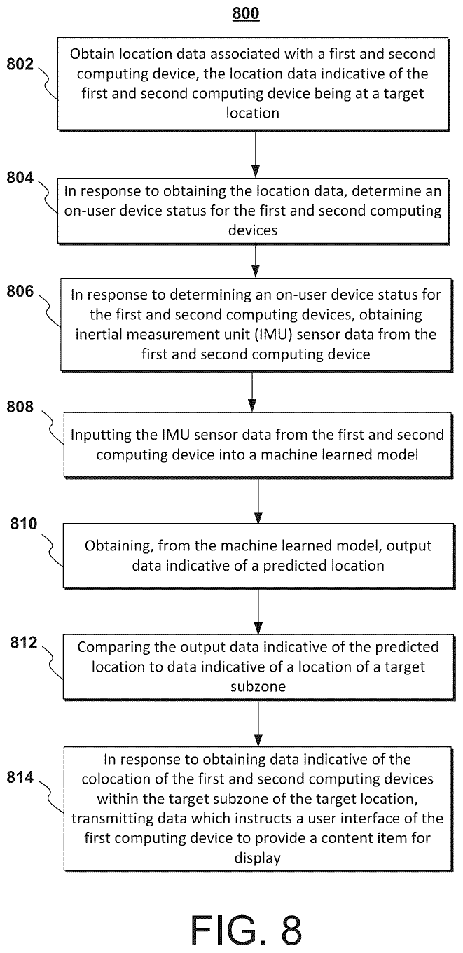

FIG. 8 depicts a flow chart diagram of an example method 800 to perform indoor user localization according to example embodiments of the present disclosure. Although FIG. 8 depicts steps performed in a particular order for purposes of illustration and discussion, the methods of the present disclosure are not limited to the particularly illustrated order or arrangement. The various steps of method 800 can be omitted, rearranged, combined, or adapted in various ways without deviating from the scope of the present disclosure.

At (802), method 800 can include obtaining location data associated with a first and second computing device, the location data indicative of the first and second computing device being at a target location. For instance, a computing system can obtain location data associated with a first and second computing device, the location data indicative of the first and second computing device being at a target location. As described herein location data can be any data indicative of a user location. For example, a user location can be determined using GPS data, cellular tower data, Wi-Fi data, or any other location data. As described herein a target location can be a physical store location or a location associated with a user (e.g., a home location, a work location). By way of example, obtaining location data indicative of the user and associated device being located at the target location (e.g., at an entrance of a relevant location) can be used as a trigger for the system to automatically perform the steps described herein. For example, in response to determining that the user has arrived at a target location (e.g., relevant location, location of interest), the computing system can obtain IMU sensor data from the respective devices.

In some implementations, the method can include obtaining location data associated with a third computing device. In some implementations the method includes obtaining IMU sensor data from the third computing device. As described herein, the method described can be performed using any number of computing devices. For example, the method described can be performed using two computing devices, three computing devices, four computing devices, up to N computing devices.

In some implementations, the first computing device comprises a smartphone, the second computing device comprises a smartwatch, and the third computing device comprises earbuds. In some implementations, the smartphone can be a primary computing device and the smartwatch and earbuds can be secondary computing devices. In some implementations the smartphone, smartwatch, and earbuds can be communicatively coupled with each other (e.g., using Bluetooth, etc.). For instance, the first computing device is a primary computing device and the second computing device is a secondary computing device. By way of example, the first computing device can function as a modem to facilitate transmission of data between the second computing device(s) and a server computing system.

At (804), method 800 can include, in response to obtaining the location data, determining an on-user device status for the first and second computing devices. For instance, a computing system can, in response to obtaining the location data, determine an on-user device status for the first and second computing devices. As described herein an on-user device status can be indicative of a computing device being located on a user. In some implementations, an on-user device status can be indicative of a computing device not being located on a user (e.g., at home, stationary on a surface).

In some implementations, the on-user device status for the first and second computing devices are indicative of the first and second computing devices are indicative of the first and second computing devices being located on a user moving inside the target location. In some implementations, an on-user device status is determined for additional computing devices associated with the user.

At (806), method 800 can include, in response to determining an on-user device status for the first and second computing devices, obtaining inertial measurement unit (IMU) sensor data from the first and second computing device. For instance, a computing system can, in response to determining an on-user device status for the first and second computing devices, obtain inertial measurement unit (IMU) sensor data from the first and second computing device. As described herein, the IMU sensor data comprises accelerometer data and gyroscope data. In some implementations, the computing is performed on the first computing device.

In some implementations, the computing system can determine an on-user device status indicative of a device not being located on the user. In response, the computing system can exclude the sensor data of the device from being obtained.

At (808), method 800 can include inputting the IMU sensor data from the first and second computing device into a machine learned model. For instance, a computing system can input the IMU sensor data from the first and second computing device into a machine learned model. As described herein, the IMU sensor data from the first and second computing devices are combined using a fusion method. In some implementations, the machine learned model is configured to transform the accelerometer data and the gyroscope data to data cartesian coordinates indicative of an absolute location. By way of example, accelerometer data and gyroscope data can be translated into cartesian coordinates via double integration. In some implementations, the IMU sensor data can be filtered. In some implementations, the machine learned model comprises a neural network. For example, the neural network can be a fully connected neural network.

In some implementations, at (808) method 800 can include inputting IMU sensor data from additional computing devices into the machine learned model (e.g., a third computing device).

At (810), method 800 can include obtaining, from the machine learned model, output data indicative of a predicted location. For instance, a computing system can obtain, from the machine learned model, output data indicative of a predicted location. As described herein the output data indicative of the predicted location can be in three degrees of freedom (e.g., cartesian coordinates, xyz coordinates). Output data can be in any form that can be utilized and compared to location data associated with a target subzone.

At (812), method 800 can include comparing the output data indicative of the predicted location to data indicative of a location of a target subzone. For instance, a computing system can compare the output data indicative of the predicted location to data indicative of a location of a target subzone. As described herein, the target subzone can be associated with a particular portion of a store (e.g., display, section, or sign). A target subzone can be associated with a particular portion of a house, office, retail space, or museum.

At (814), method 800 can include, in response to obtaining data indicative of the colocation of the first and second computing devices within the target subzone of the target location, transmitting data which instructs a user interface of the first computing device to provide a content item for display. For instance, a computing system can, in response to obtaining data indicative of the colocation of the first and second computing devices within the target subzone of the target location, transmit data which instructs a user interface of the first computing device to provide a content item for display. As described herein, the content item for display can be associated with a third-party (e.g., content provider, advertiser). By way of example, the content item can be related to the target subzone. For example, a target subzone can be associated with a section of store with a specific t-shirt brand. The content item could be associated with additional information for the t-shirt brand, a coupon for the shirt, or an advertisement associated with the shirt. In some implementations, the target subzone can be a portion of a museum. In some implementations, the content item can be associated with the portion of the museum (e.g., a particular historical display, piece of art, etc.). In some implementations, the content item can be a selectable user interface element (e.g., that can be selected by a user to perform an action such as turn on or control a light, TV, speaker, or other device).

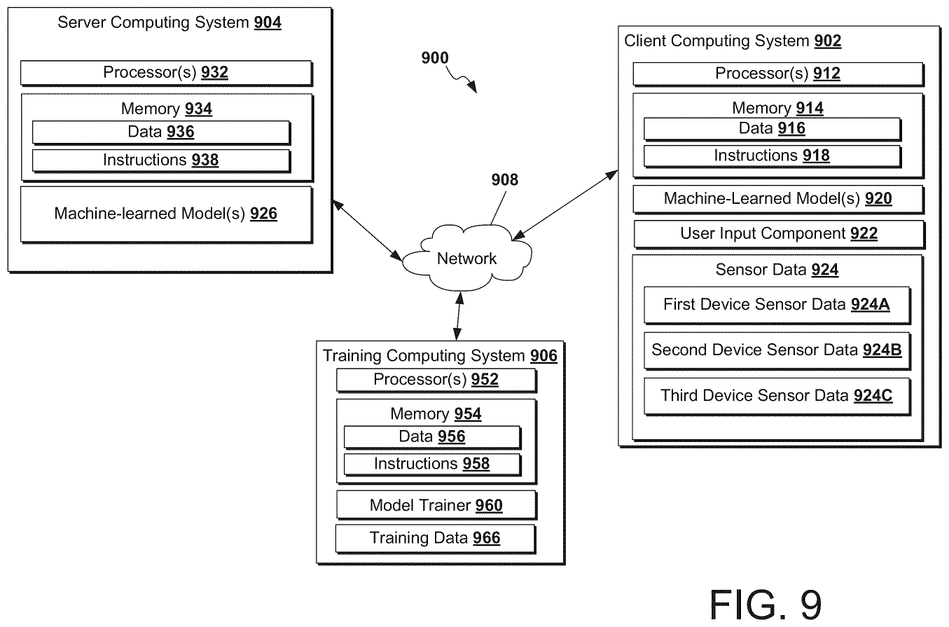

FIG. 9 depicts a block diagram of an example computing system 900 that generates, trains, or uses machine learned models to predict indoor localization of user devices associated with a user according to example embodiments of the present disclosure. The computing system 900 includes a client computing system 902, a server computing system 904, and a training computing system 906 that are communicatively coupled over a network 908.

The client computing system 902 can be any type of computing device, such as, for example, a mobile computing device (e.g., smartphone or tablet), a wearable computing device, a personal computing device (e.g., laptop or desktop), a gaming console or controller, an embedded computing device, or any other type of computing device.

The client computing system 902 includes one or more processors 912 and a memory 914. The one or more processors 912 can be any suitable processing device (e.g., a processor core, a microprocessor, an ASIC, an FPGA, a controller, a microcontroller, etc.) and can be one processor or a plurality of processors that are operatively connected. The memory 914 can include one or more computer-readable storage media which may be transitory or may be non-transitory, such as RAM, ROM, EEPROM, EPROM, flash memory devices, magnetic disks, etc., and combinations thereof. The memory 914 can store data 916 and instructions 918 which are executed by the processor 912 to cause the client computing system 902 to perform operations.

In some implementations, the client computing system 902 can store or include one or more machine-learned models 920. For example, the machine-learned models 920 can be or can otherwise include various machine-learned models such as neural networks (e.g., fully connected neural networks, deep neural networks) or other types of machine-learned models, including non-linear models or linear models. Neural networks can include feed-forward neural networks, recurrent neural networks (e.g., long short-term memory recurrent neural networks), convolutional neural networks, fully connected neural networks, or other forms of neural networks. Some example machine-learned models can leverage an attention mechanism such as self-attention. For example, some example machine-learned models can include multi-headed self-attention models (e.g., transformer models). Example machine-learned models 920 are discussed with reference to FIGS. 5, 6, and 7.

In some implementations, the one or more machine-learned models 920 can be received from the server computing system 904 over network 908, stored in the user computing device memory 914, and then used or otherwise implemented by the one or more processors 912. In some implementations, the client computing system 902 can implement multiple parallel instances of a single machine-learned model 920 (e.g., to perform a fusion action on the IMU sensor data, transform the IMU sensor data to three degrees of freedom data, or determine a predicted location of the user).

More particularly, the machine learned model can obtain sensor data associated with one or more user devices (e.g., first device sensor data 924A, second device sensor data 924B, third device sensor data 924C). The sensor data can be associated with one or more sensors associated with one of more user devices. For example, sensors can include inertial measurement unit (IMU) sensors, ambient light sensors, accelerometer (e.g., 3-axis accelerometer), altimeter (detects change in height), optical hear rate sensor (detect heart beats per minute), SpO2 monitor (e.g., to measure blood oxygen levels), bioimpedance sensor(s), proximity sensor (e.g., to save battery and wake display when needed), compass, GPS, gyroscope, gesture sensors, ultraviolet (UV) sensor, magnetometer, electrodermal activity sensor, skin temperature sensor, accelerometer(s), gyroscope(s), magnetometer(s), global positioning system (GPS), heart rate sensor(s) (e.g., electrode sensor or photodiode), pedometer(s) (e.g., electrical, mechanical, or microelectromechanical), pressure sensor(s) (e.g., strain gauges), optical sensors, audio sensors, or other sensors. Sensor data can include gravity acceleration, linear acceleration, angular acceleration, rotational acceleration, inertial measure unit (e.g., generated using accelerometers or gyroscopes), motion orientation, location (e.g., detected via satellite), strain, pressure, resistance changes (e.g., static or dynamic).

In some embodiments, the training data 966 can include ground truth data associated with an absolute location (or associated trajectory) of a user indoor. For example, ground truth data can be obtained from a database. The database can be populated via experiments (e.g., conducted in a lab, in a real-life indoor location). The computing system can retrieve, suggest, or generate one or more content items in response to determining a predicted user location.

Additionally, or alternatively, one or more machine-learned models 926 can be included in or otherwise stored and implemented by the server computing system 904 that communicates with the client computing system 902 according to a client-server relationship. For example, the machine-learned models 926 can be implemented by the server computing system 904 as a portion of a web service (e.g., a content serving service, location determination service, localization service, a campaign management service, a content strategy management service). Thus, one or more machine-learned models 920 can be stored and implemented at the client computing system 902 or one or more models 926 can be stored and implemented at the server computing system 904.

The client computing system 902 can also include one or more user input components 122 that can receive user input. For example, the user input component 922 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The client computing system can include sensor data from sensor database 924. Sensor data from sensor database 924 can include first device sensor data 924A, second device sensor data 924B, or third device sensor data 924C. First device sensor data 924A can include data obtained via one or more sensors associated with a first device. For example, first device sensor data 924A can include sensor data from sensor database 924. Sensor data from sensor database 924 can include gravity acceleration, linear acceleration, angular acceleration, rotational acceleration, inertial measure unit (e.g., generated using accelerometers or gyroscopes), motion orientation, location (e.g., detected via satellite), strain, pressure, or resistance changes (e.g., static or dynamic). The sensor data from sensor database 924 can be used by client computing system 902 to be processed by machine-learned model(s) (and associated prediction pipeline) to determine a predicted location of the user (and associated user devices). The computing system can use the predicted location of the user (e.g., and the sensor data from sensor database 924) to send a request to server computing system 904 for one or more content items (e.g., message, image, video, selectable user interface element, advertisement). The computing system can cause the one or more suggested content items to be retrieved, generated, or presented to a user via a user interface of a device (e.g., user device).

The server computing system 904 includes one or more processors 932 and a memory 934. The one or more processors 932 can be any suitable processing device (e.g., a processor core, a microprocessor, an ASIC, an FPGA, a controller, a microcontroller, etc.) and can be one processor or a plurality of processors that are operatively connected. The memory 934 can include one or more computer-readable storage media which may be transitory or may be non-transitory, such as RAM, ROM, EEPROM, EPROM, flash memory devices, magnetic disks, etc., and combinations thereof. The memory 934 can store data 936 and instructions 938 which are executed by the processor 932 to cause the server computing system 904 to perform operations.

In some implementations, the server computing system 904 includes or is otherwise implemented by one or more server computing devices. In instances in which the server computing system 904 includes plural server computing devices, such server computing devices can operate according to sequential computing architectures, parallel computing architectures, or some combination thereof.

As described above, the server computing system 904 can store or otherwise include one or more machine-learned models 926. For example, the machine-learned models 926 can be or can otherwise include various machine-learned models. Example machine-learned models include neural networks or other multi-layer non-linear models. Example neural networks include feed forward neural networks, fully connected neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example machine-learned models 926 are discussed with reference to FIGS. 5, 6, and 7.

The client computing system 902 or the server computing system 904 can train the machine-learned models 920 or 926 via interaction with the training computing system 906 that is communicatively coupled over the network 908. The training computing system 906 can be separate from the server computing system 904 or can be a portion of the server computing system 904.

The training computing system 906 includes one or more processors 952 and a memory 954. The one or more processors 952 can be any suitable processing device (e.g., a processor core, a microprocessor, an ASIC, an FPGA, a controller, a microcontroller, etc.) and can be one processor or a plurality of processors that are operatively connected. The memory 954 can include one or more computer-readable storage media which may be transitory or may be non-transitory, such as RAM, ROM, EEPROM, EPROM, flash memory devices, magnetic disks, etc., and combinations thereof. The memory 954 can store data 956 and instructions 958 which are executed by the processor 952 to cause the training computing system 906 to perform operations. In some implementations, the training computing system 906 includes or is otherwise implemented by one or more server computing devices (e.g., the server computing system 904).

The training computing system 906 can include a model trainer 960 that trains the machine-learned models 920 or 926 stored at the client computing system 902 or the server computing system 904 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, or various other loss functions. Gradient descent techniques can be used to iteratively update the parameters over a number of training iterations.

In some implementations, performing backwards propagation of errors can include performing truncated backpropagation through time. The model trainer 960 can perform a number of generalization techniques (e.g., weight decays, dropouts, etc.) to improve the generalization capability of the models being trained.

In particular, the model trainer 960 can train machine learned models 920 or 926 based on a set of training data 966. The training data 966 can include, for example, ground truth location data. For example, the ground truth location data can be data correctly transformed from IMU sensor data to three degrees of freedom location data, IMU sensor data compared to ground truth three degrees of freedom location data.

In some implementations, if the user has provided consent, the training examples can be provided by the client computing system 902. Thus, in such implementations, the machine-learned model 920 provided to the client computing system 902 can be trained by the training computing system 906 on user-specific data received from the client computing system 902. In some instances, this process can be referred to as personalizing the model.

The model trainer 960 includes computer logic utilized to provide desired functionality. The model trainer 960 can be implemented in hardware, firmware, or software controlling a general-purpose processor. For example, in some implementations, the model trainer 960 includes program files stored on a storage device, loaded into a memory and executed by one or more processors. In other implementations, the model trainer 960 includes one or more sets of computer-executable instructions that are stored in a tangible computer-readable storage medium such as RAM, hard disk, or optical or magnetic media.

The network 908 can be any type of communications network, such as a local area network (e.g., intranet), wide area network (e.g., Internet), or some combination thereof and can include any number of wired or wireless links. In general, communication over the network 908 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

The machine-learned models described in this specification may be used in a variety of tasks, applications, or use cases.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some implementations, the input to the machine-learned model(s) of the present disclosure can be statistical data. Statistical data can be, represent, or otherwise include data computed or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some cases, the machine-learned model(s) can be configured to perform a task that includes encoding input data for reliable or efficient transmission or storage (or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data).

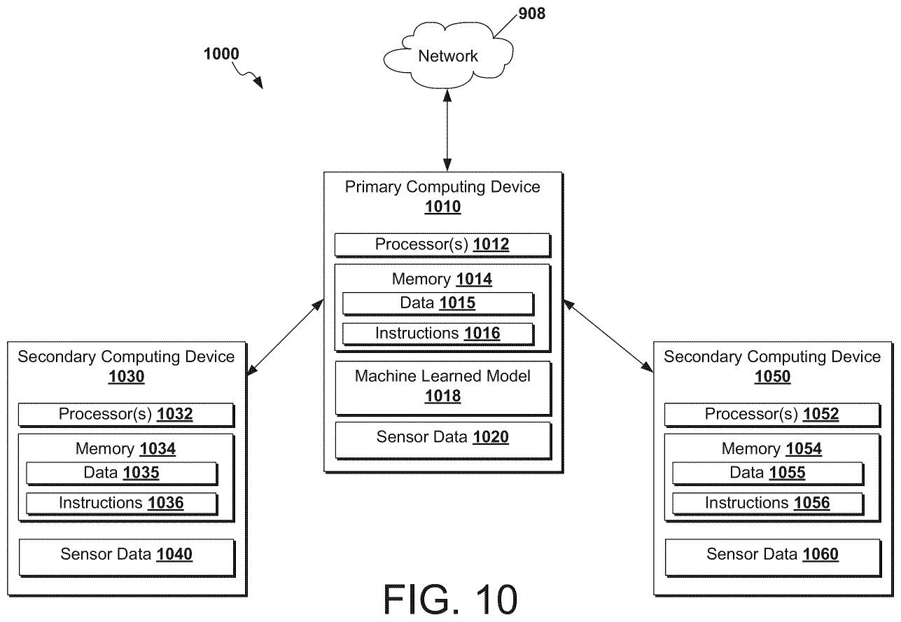

In some implementations, a client computing system 902 can include a plurality of computing devices. The client devices can communicate directly over network 908 with server computing system 904 or training computing system 906. In some implementations, client computing system can include a plurality of computing with a primary client device as depicted in FIG. 10.

FIG. 10 depicts a block diagram of an example computing system 1000 that generates, trains, or uses machine learned models to predict indoor localization of user devices associated with a user according to example embodiments of the present disclosure. The computing system 1000 includes a primary computing device 1010, and secondary computing device 1030, and secondary computing device 1050. In some implementations the computing devices can be associated with a client computing system (e.g., client computing system 902 depicted in FIG. 9). In some implementations, secondary computing devices 1030 and 1050 can be communicatively coupled to primary computing device (e.g., over a network (cellular or wireless), via a Bluetooth connection). For instance, secondary computing devices 1030 and can be tethered to primary computing device 1010. In some implementations, primary computing device 1010 can be used as a modem connect one or more secondary devices (e.g., secondary device 1030 or 1050) to a network (e.g., network 908). By way of example, primary computing device 1010 can be communicatively coupled over a network to a server computing system (e.g., server computing system 904) or training computing system (e.g., training computing system 906) that are communicatively coupled over a network 908.

Primary computing device 1010 can be any type of computing device, such as for example, a mobile computing device (e.g., smartphone or tablet). Client computing system 902 can be any type of computing device, such as, for example, a mobile computing device (e.g., smartphone or tablet), a wearable computing device, a personal computing device (e.g., laptop or desktop), a gaming console or controller, an embedded computing device, or any other type of computing device.

Primary computing device 1010 includes one or more processors 1012 and a memory 1014. The one or more processors 1012 can be any suitable processing device (e.g., a processor core, a microprocessor, an ASIC, an FPGA, a controller, a microcontroller, etc.) and can be one processor or a plurality of processors that are operatively connected. The memory 1014 can include one or more computer-readable storage media which may be transitory or may be non-transitory, such as RAM, ROM, EEPROM, EPROM, flash memory devices, magnetic disks, etc., and combinations thereof. The memory 1014 can store data 1015 and instructions 1016 which are executed by the processor 1012 to cause the primary computing device 1010 to perform operations.

In some implementations, primary computing device 1010 can store or include one or more machine-learned models 1018. For example, the machine-learned models 1018 can be or can otherwise include various machine-learned models such as neural networks (e.g., deep neural networks) or other types of machine-learned models, including non-linear models or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 1018 are discussed with reference to FIGS. 5, 6, 7, and 9.

In some implementations, the one or more machine-learned models 1018 can be received from a server computing system (e.g., server computing system 904) over network 908, stored in the user computing device memory 1014, and then used or otherwise implemented by the one or more processors 1012. In some implementations, the primary computing device 1010 can implement multiple parallel instances of a single machine-learned model 1018 (e.g., to perform a fusion action on the IMU sensor data, transform the IMU sensor data to three degrees of freedom data, or determine a predicted location of the user).

More particularly, the machine learned model can obtain sensor data associated with one or more user devices (e.g., sensor data 1020, sensor data 1040, or sensor data 1060). The sensor data can be associated with primary computing device 1010, secondary computing device 1030, or secondary computing device 1050. For example, sensors can include inertial measurement unit (IMU) sensors, ambient light sensors, accelerometer (e.g., 3-axis accelerometer), altimeter (detects change in height), optical hear rate sensor (detect heart beats per minute), SpO2 monitor (e.g., to measure blood oxygen levels), bioimpedance sensor(s), proximity sensor (e.g., to save battery and wake display when needed), compass, GPS, gyroscope, gesture sensors, ultraviolet (UV) sensor, magnetometer, electrodermal activity sensor, skin temperature sensor, accelerometer(s), gyroscope(s), magnetometer(s), global positioning system (GPS), heart rate sensor(s) (e.g., electrode sensor or photodiode), pedometer(s) (e.g., electrical, mechanical, or microelectromechanical), pressure sensor(s) (e.g., strain gauges), optical sensors, audio sensors, or other sensors. Sensor data can include gravity acceleration, linear acceleration, angular acceleration, rotational acceleration, inertial measure unit (e.g., generated using accelerometers or gyroscopes), motion orientation, location (e.g., detected via satellite), strain, pressure, resistance changes (e.g., static or dynamic).

Secondary computing device 1030 can be any type of computing device, such as, for example, a mobile computing device (e.g., smartphone or tablet), a wearable computing device, a personal computing device (e.g., laptop or desktop), a gaming console or controller, an embedded computing device, or any other type of computing device.

Secondary computing device 1030 includes one or more processors 1032 and a memory 1034. The one or more processors 1032 can be any suitable processing device (e.g., a processor core, a microprocessor, an ASIC, an FPGA, a controller, a microcontroller, etc.) and can be one processor or a plurality of processors that are operatively connected. The memory 1034 can include one or more computer-readable storage media which may be transitory or may be non-transitory, such as RAM, ROM, EEPROM, EPROM, flash memory devices, magnetic disks, etc., and combinations thereof. The memory 1034 can store data 1035 and instructions 1036 which are executed by the processor 1032 to cause the primary computing device 1010 to perform operations.

Secondary computing device 1050 can be any type of computing device, such as, for example, a mobile computing device (e.g., smartphone or tablet), a wearable computing device, a personal computing device (e.g., laptop or desktop), a gaming console or controller, an embedded computing device, or any other type of computing device.

Secondary computing device 1050 includes one or more processors 1052 and a memory 1054. The one or more processors 1052 can be any suitable processing device (e.g., a processor core, a microprocessor, an ASIC, an FPGA, a controller, a microcontroller, etc.) and can be one processor or a plurality of processors that are operatively connected. The memory 1054 can include one or more computer-readable storage media which may be transitory or may be non-transitory, such as RAM, ROM, EEPROM, EPROM, flash memory devices, magnetic disks, etc., and combinations thereof. The memory 1054 can store data 1055 and instructions 1056 which are executed by the processor 1052 to cause the primary computing device 1010 to perform operations.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

The depicted or described steps are merely illustrative and can be omitted, combined, or performed in an order other than that depicted or described; the numbering of depicted steps is merely for ease of reference and does not imply any particular ordering is necessary or preferred.

The functions or steps described herein can be embodied in computer-usable data or computer-executable instructions, executed by one or more computers or other devices to perform one or more functions described herein. Generally, such data or instructions include routines, programs, objects, components, data structures, or the like that perform particular tasks or implement particular data types when executed by one or more processors in a computer or other data-processing device. The computer-executable instructions can be stored on a computer-readable medium such as a hard disk, optical disk, removable storage media, solid-state memory, read-only memory (ROM), random-access memory (RAM), or the like. As will be appreciated, the functionality of such instructions can be combined or distributed as desired. In addition, the functionality can be embodied in whole or in part in firmware or hardware equivalents, such as integrated circuits, application-specific integrated circuits (ASICs), field-programmable gate arrays (FPGAs), or the like. Particular data structures can be used to implement one or more aspects of the disclosure more effectively, and such data structures are contemplated to be within the scope of computer-executable instructions or computer-usable data described herein.

Although not required, one of ordinary skill in the art will appreciate that various aspects described herein can be embodied as a method, system, apparatus, or one or more computer-readable media storing computer-executable instructions. Accordingly, aspects can take the form of an entirely hardware embodiment, an entirely software embodiment, an entirely firmware embodiment, or an embodiment combining software, hardware, or firmware aspects in any combination.

As described herein, the various methods and acts can be operative across one or more computing devices or networks. The functionality can be distributed in any manner or can be located in a single computing device (e.g., server, client computer, user device, or the like).

Aspects of the disclosure have been described in terms of illustrative embodiments thereof. Numerous other embodiments, modifications, or variations within the scope and spirit of the appended claims can occur to persons of ordinary skill in the art from a review of this disclosure. For example, one or ordinary skill in the art can appreciate that the steps depicted or described can be performed in other than the recited order or that one or more illustrated steps can be optional or combined. Any and all features in the following claims can be combined or rearranged in any way possible.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, or equivalents to such embodiments. Accordingly, the subject disclosure does not preclude inclusion of such modifications, variations, or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, or equivalents.

Terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

1. A computing system, comprising:
one or more processors; and
one or more computer-readable media storing instructions that are executable to cause the one or more processors to perform operations, the operations comprising:
obtaining location data associated with a first computing device and a second computing device, the location data indicative of the first computing device and the second computing device each being at a target location;
in response to obtaining the location data, determining an on-user device status for the each of the first and second computing devices;
in response to determining an on-user device status for each of the first and second computing devices, obtaining inertial measurement unit (IMU) sensor data from each of the first and second computing devices;
inputting the IMU sensor data from each of the first and second computing devices into a machine learned model, wherein the machine learned model is configured to combine the IMU sensor data from each of the first and second computing devices;
obtaining, from the machine learned model, output data indicative of a predicted location;
comparing the output data indicative of the predicted location to data indicative of a location of a target subzone; and
in response to obtaining data indicative of colocation of each of the first and second computing devices within the target subzone of the target location, transmitting data which instructs a user interface of the first computing device to provide a content item for display.

2. The system of claim 1, wherein the on-user device status for each of the first and second computing devices are indicative of each of the first and second computing devices being located on a user moving inside the target location.

3. The system of claim 1, wherein the IMU sensor data comprises accelerometer data and gyroscope data.

4. The system of claim 3, wherein the machine learned model is configured to transform the accelerometer data and the gyroscope data to data cartesian coordinates indicative of an absolute location.

5. The system of claim 1, further comprising obtaining IMU sensor data from a third computing device.

6. The system of claim 5, wherein the first computing device comprises a smartphone, the second computing device comprises a smartwatch, and the third computing device comprises earbuds.

7. The system of claim 1, wherein the computing is performed on the first computing device.

8. The system of claim 1, wherein the IMU sensor data from each of the first and second computing devices are combined using a fusion method.

9. The system of claim 1, wherein the machine learned model comprises a neural network.

10. The system of claim 1, wherein the machine learned model comprises a fully connected neural network.

11. A computer-implemented method comprising:
obtaining location data associated with a first computing device and a second computing device, the location data indicative of the first computing device and the second computing device each being at a target location;
in response to obtaining the location data, determining an on-user device status for the each of the first and second computing devices;
in response to determining an on-user device status for each of the first and second computing devices, obtaining inertial measurement unit (IMU) sensor data from each of the first and second computing device;
inputting the IMU sensor data from each of the first and second computing devices into a machine learned model, wherein the machine learned model is configured to combine the IMU sensor data from each of the first and second computing devices;
obtaining, from the machine learned model, output data indicative of a predicted location;
comparing the output data indicative of the predicted location to data indicative of a location of a target subzone; and
in response to obtaining data indicative of colocation of each of the first and second computing devices within the target subzone of the target location, transmitting data which instructs a user interface of the first computing device to provide a content item for display.

12. The computer-implemented method of claim 11, wherein the on-user device status for each of the first and second computing devices are indicative of each of the first and second computing devices being located on a user moving inside the target location.

13. The computer-implemented method of claim 11, wherein the IMU sensor data comprises accelerometer data and gyroscope data.

14. The computer-implemented method of claim 13, wherein the machine learned model is configured to transform the accelerometer data and the gyroscope data to data cartesian coordinates indicative of an absolute location.

15. The computer-implemented method of claim 11, further comprising obtaining IMU sensor data from a third computing device.

16. The computer-implemented method of claim 15, wherein the first computing device comprises a smartphone, the second computing device comprises a smartwatch, and the third computing device comprises earbuds.

17. (canceled)

18. The computer-implemented method of claim 11, wherein the IMU sensor data from each of the first and second computing devices are combined using a fusion method.

19. The computer-implemented method of claim 11, wherein the machine learned model comprises a neural network.

20. The computer-implemented method of claim 11, wherein the first device is a primary computing device and the second computing device is a secondary computing device, and wherein the first device functions as a modem to facilitate transmission of data between the second device and a server computing system.

21. A non-transitory computer readable medium embodied in a computer-readable storage device and comprising instructions that, when executed by a processor, cause the processor to perform operations, the operations comprising:
obtaining location data associated with a first computing device and a second computing device, the location data indicative of the first computing device and the second computing device each being at a target location;
in response to obtaining the location data, determining an on-user device status for the each of the first and second computing devices;
in response to determining an on-user device status for each of the first and second computing devices, obtaining inertial measurement unit (IMU) sensor data from each of the first and second computing devices;
inputting the IMU sensor data from each of the first and second computing devices into a machine learned model, wherein the machine learned model is configured to combine the IMU sensor data from each of the first and second computing devices;
obtaining, from the machine learned model, output data indicative of a predicted location;
comparing the output data indicative of the predicted location to data indicative of a location of a target subzone; and
in response to obtaining data indicative of colocation of each of the first and second computing devices within the target subzone of the target location, transmitting data which instructs a user interface of the first computing device to provide a content item for display.
